(19) United States
(12) Patent Application Publication
(10) Pub. No.: US 2009/0092954 A1
(43) Pub. Date: Apr. 9, 2009

(54) Recording interactions

(76) Inventor: Richard Ralph Crook, Sheffield (GB)

Correspondence Address: JAMES C. WRAY, 1493 CHAIN BRIDGE ROAD, SUITE 300, MCLEAN, VA, 22101, US

(21) Appl. No.: 12/070,621

(22) Filed: Feb. 20, 2008

(30) Foreign Application Priority Data
Oct. 9, 2007 (GB) 07 19 652.0

(51) Int. Cl. G09B 19/00

(52) U.S. Cl. 434/238

(57) ABSTRACT

The recording of an interaction between an authorised host and at least one subject, for use in reinforcing good behaviour of the subject, is disclosed. A counsellor is hosted at a central station and subjects are received at one or more counselling stations. The central station and the subject receiving stations are connected by a network. An interaction between a subject and an authorised host is recorded and the authorised host adds related textural data to a relational database.

### CROSS REFERENCE TO RELATED APPLICATIONS

This application claims priority from United Kingdom Patent Application No. 07 19 652.0, filed 9 Oct. 2007, the entire disclosure of which is incorporated herein by reference in its entirety.

### TECHNICAL FIELD

The present invention relates to the recording of an interaction between an authorised host and each of a plurality of subjects, for use in reinforcing good behaviour the subject.

### BACKGROUND OF THE INVENTION

Techniques for the recording of interactions between counsellors and subjects are well known but in these known applications the purpose of the recording is subsidiary to the counselling process itself. The technology is in addition to the counselling process and does not directly influence the counselling process itself. The present invention is directed towards seeking a technical input and a technical contribution in order to enhance a counselling interaction.

### BRIEF SUMMARY OF THE INVENTION

According to an aspect of the present invention, there is provided apparatus for recording interactions between an authorised host and each of a plurality of subjects, for use in reinforcing good behaviour of the subject, comprising: a central station for hosting said authorised host; a plurality of interview stations for receiving subjects; a network for connecting the central station to the interview stations; and a database for recording details of interactions between the authorised host and received subjects, wherein: each of said interview stations comprises a substantially enclosed pod-like structure for receiving a subject and devices for establishing an audio and video connection to the central station via the network; and the central station includes devices for maintaining an audio and video connection with an interview station to maintain an audio and video interaction between the authorised host and a received subject, audio and video recording equipment for recording interactions, and an input device for receiving textural input from the authorised host thereby allowing the authorised host to populate appropriate fields of the database.

In a preferred embodiment, the database includes details of recorded audio and video so as to relate the audio and video to data entries.

According to a second aspect of the present invention, there is provided a method of recording interactions between an authorised host and each of a plurality of subjects, for use in reinforcing good behaviour of the subject, comprising the steps of: hosting an authorised host at a central station; receiving a subject at a subject receiving station; and connecting the central station to the subject receiving station by a network, wherein an interaction between a subject and the authorised host is recorded; and the authorised host adds related textural data to a relational database.

In a preferred embodiment the invention takes place in an educational environment and a plurality of educational environments may each have access to a respective counselling station and each of said counselling stations may communicate with a central station over the network. In a preferred embodiment the counsellor provides positive feedback or praise to an interacting subject and the subject may be provided with a recording of the interaction.

### BRIEF DESCRIPTION OF THE SEVERAL VIEWS OF THE DRAWINGS

FIG. 1 shows an environment for the recording of interactions between an expert counsellor and a plurality of subjects;

FIG. 2 illustrates a situation;

FIG. 3 illustrates a teacher giving instruction;

FIG. 4 illustrates the sending of a child to a praise pod;

FIG. 5 illustrates a praise pod;

FIG. 6 shows the operational equipment contained within the praise pod of FIG. 5;

FIG. 7 shows a counsellor;

FIG. 8 shows the interactive environment provided to the counsellor at the central station;

FIG. 9 details the computer system of FIG. 8;

FIG. 10 shows an example of a database table;

FIG. 11 illustrates the derivation of a recording;

FIG. 12 illustrates the use of recordings;

FIG. 13 shows the further distribution of recordings;

FIG. 14 illustrates further use of recordings;

FIG. 15 illustrates shows a further example of a database table; and

FIG. 16 illustrates options presented by a screen.

### DESCRIPTION OF THE BEST MODE FOR CARRYING OUT THE INVENTION

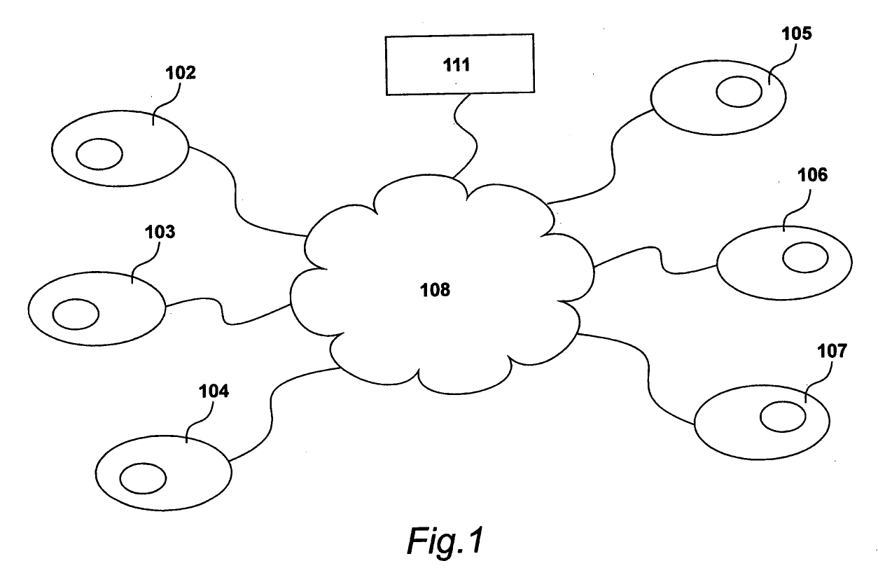

### FIG. 1

An environment for the recording of interactions between an expert counsellor and a plurality of subjects is illustrated in FIG. 1. The environment includes a central station 101 and a plurality of interview stations 102, 103, 104, 105, 106, 107 etc. The central station 101 communicates with the interview stations 102 to 107 via a network 108.

In a preferred embodiment, the central station 101 includes a database for recording details of interactions between the counsellor and the subjects. Each of the interview stations, such as station 102, comprises a substantially enclosed pod-like structure for receiving a subject, along with devices for establishing an audio and video connection to the central station 101 via the network 108.

The central station 101 also includes devices for maintaining an audio and video connection with an interview station (such as station 102) so as to maintain an audio and video interaction between the counsellor, based at the central station 101 and the subject, calling from interview station 102. Preferably the central station 101 also includes audio and video recording equipment for recording interactions and an input device for receiving textural input from the counsellor thereby allowing the counsellor to populate appropriate fields in the database.

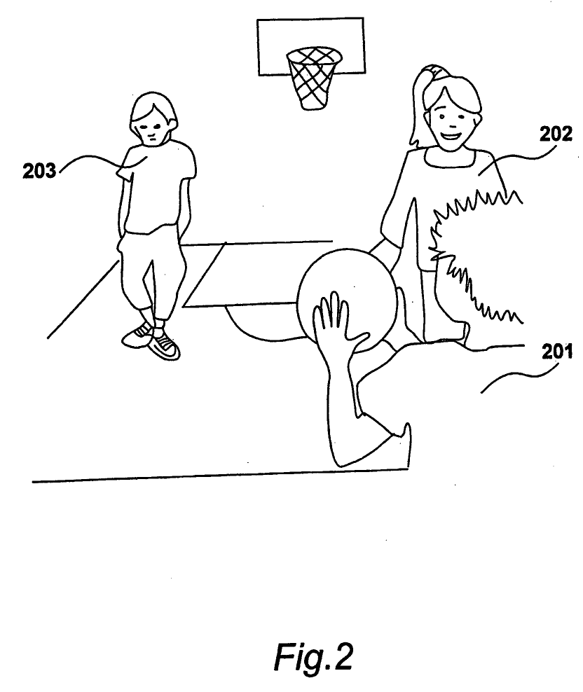

### FIG. 2

In a general sense, the present proposal relates to the recording of an interaction between a counsellor and a plurality of subjects. The approach involves hosting a counsellor at a central station and entertaining a subject at a counselling station. The counselling station, of which there may be many, as illustrated in FIG. 1, is connected to the central station via a network. An interaction between a subject and a counsellor is recorded and the counsellor is then in a position to add related textural data to a relational database.

In a preferred embodiment, the interaction takes place in an educational environment where, preferably, many educational establishments have access to a respective counselling station and each of the counselling stations communicates with a central station over the network.

Development work with respect to the exploitation of the environment has been performed in educational situations in which a counsellor provides positive feedback or praise to interacting subjects, ie students. The system will therefore be described in detail with reference to this particular application although it should be appreciated that many other applications are possible, making use of the technical features developed herein.

A situation is illustrated in FIG. 1 in which a first child 201 is playing a ball game with a second child 202. First child 201 notices that a third child 203 appears to be on his own and looks somewhat upset. Of his own volition, the first child 202 invites the third child to join the game, thereby establishing a friendly and co-operative working environment.

An initial brief for the application was directed towards helping organisations share and reinforce good things. It may be considered as a key tool in connecting communities and promoting an infectious culture of praise. The apparatus itself provides a technical input for automating and reinforcing this process, from capture, through recording to search and retrieval functions. The processes will refer specifically to a single application herein; that of use within a primary school. However, as previously stated, the process can be adapted to other environments including corporate markets.

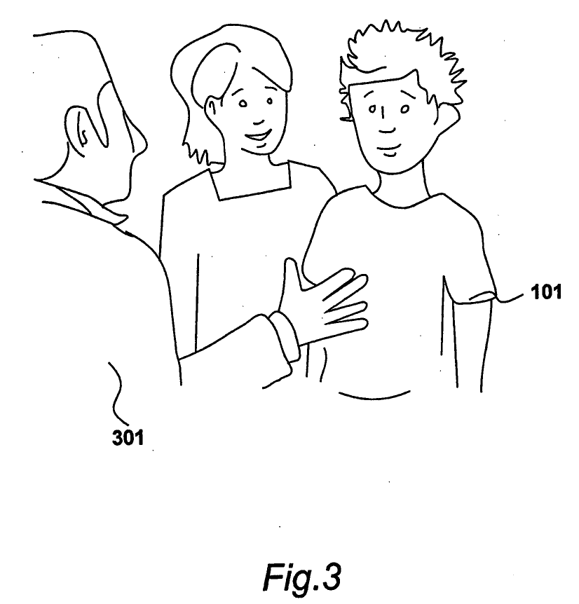

### FIG. 3

The kind actions of child 101 described with reference to FIG. 2 are brought to the attention of a teacher 301, as shown in FIG. 3. The teacher expresses to child 101 that his actions were considered very thoughtful and that he should go to the “praise pod”, a proprietary name used herein to identify the apparatus. This should not be confused with generic representations and is presently considered to be a trademark of the current applicant. Thus, the noticing of good behaviour is the start of the whole process of reinforcement. Praise pod helps staff reinforce good things by making it easy to reward them. This may be considered as the start of the circle of praise.

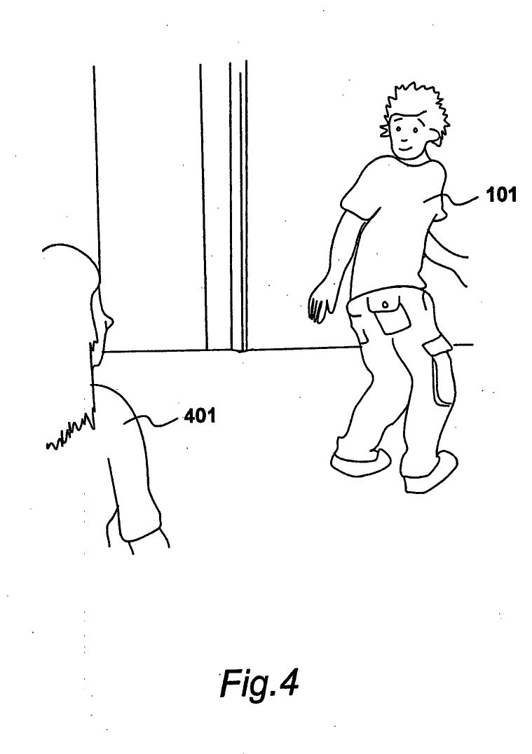

### FIG. 4

Child 101 is sent to the praise pod by a member of staff. Even the act of going to the pod may be seen as praise in itself such that child 101 is seen by a fourth student 401 who may ask why he is on his way to the pod. Thus, it is not necessary in the school itself for the nature of the good behaviour to be explained on every occasion. The fact that a child has attended the praise pod would in itself be seen as a good thing.

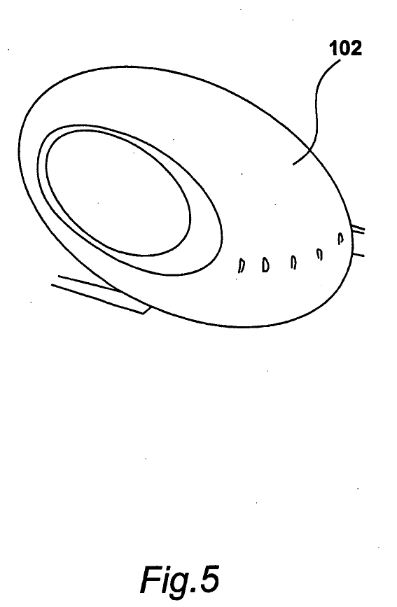

### FIG. 5

Praise pod 102 is shown in FIG. 5. Operations performed at the praise pod 102 are substantially automated and additional assistance from other members of staff is minimised. The child 101 includes a means of identification which may take the form of a card for example that is swiped within a card reader. A swipe card may be unique to the praise pod, or praise pod swipe functionality may be incorporated in a card provided for one or more other uses, such as a payment card, a pupil identification card or a class attendance registration card for example. Alternatively, a touch screen or similar input device could be provided allowing the child to identify themselves to the equipment.

At this time a remote interviewer, that is the counsellor at the central station 101, is alerted to the effect that someone is in a praise pod and that an interaction has been requested. This authorised host may be waiting during an time slot allocated to them for providing this service. The counsellor will also be provided with the name and age of the child concerned, along with any other details that may be considered appropriate such as a class designation.

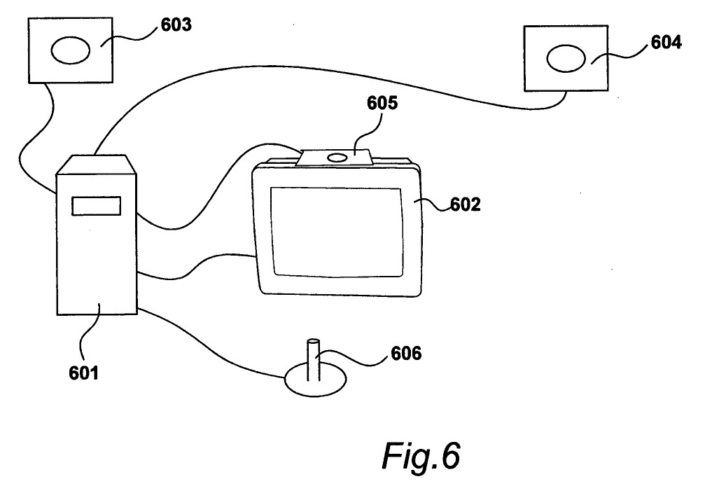

### FIG. 6

Operational equipment within the praise pod 102 is detailed in FIG. 6. In this embodiment, the equipment includes a computer system 601 and a video display unit 602 for displaying images to a subject. Audio signals are played to the subject via loudspeakers 603, 604. The system also includes a video camera 605 and a microphone 606. Thus, images from the praise pod 102 and utterances made at the praise pod 102 are processed by the computer system 601 and supplied digitally over network 108 to the central station 101.

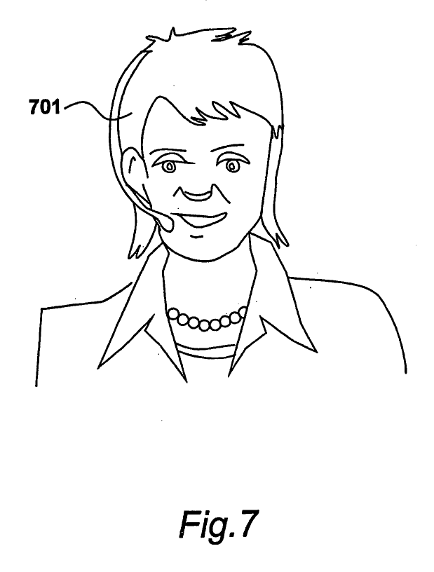

### FIG. 7

At the central station 101 a counsellor wears an audio headset 701, having a microphone and an earpiece. In this way, a video link is established between the subject and the counsellor. In the example, the child 101 may state that child 203 looked really sad so asked him if he wanted to join the game. The counsellor could reply to the effect that his parents will be really proud of him when he tells them that evening. Furthermore, the telling of the story to parents may in the preferred embodiment, be reinforced by the ability of child 101 to be provided with a recording of the praise pod encounter.

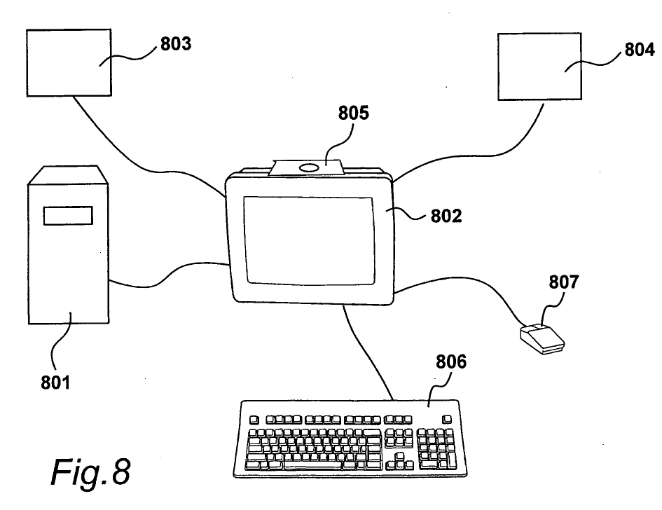

### FIG. 8

At the central station 101 the counsellor (shown in FIG. 7) is provided with a similar interactive environment, including a computer system 801, a display unit 802, loudspeakers 803, 804 and a video camera 805. In addition, the counsellor is provided with input devices, such as a keyboard 806 and a mouse 807.

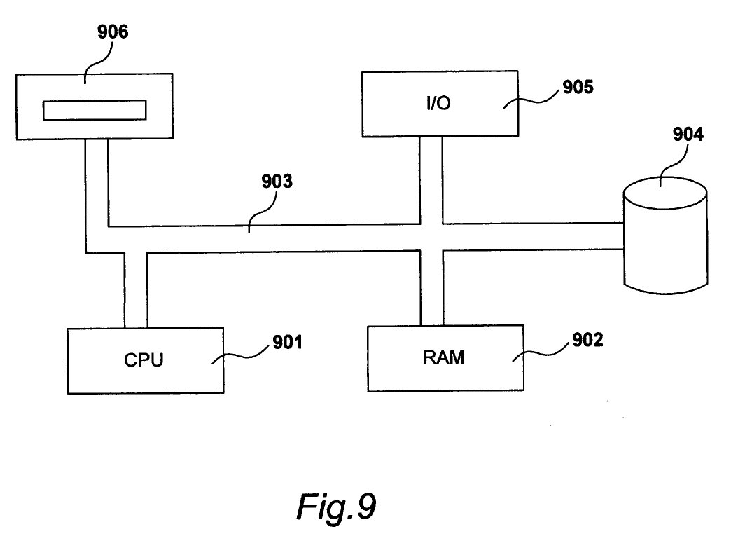

### FIG. 9

Computer system 801 identified in FIG. 8 is detailed in FIG. 9. This includes a central processing unit 901 and randomly accessible memory devices 902. Processing unit 901 and randomly accessible memory devices 902 communicate via a system bus 903, that also communicates with a disk storage device 904, input/output interfaces 905 and a video recording device 906, such as a DVD writer.

In addition to executing programs for the establishment of the video link, CPU 901, upon receiving instructions from randomly addressable memory device 902, also executes database instructions, to facilitate the creation, reading, manipulating and writing of databases. In particular, it is possible for the counsellor to populate database tables during a video encounter with a subject.

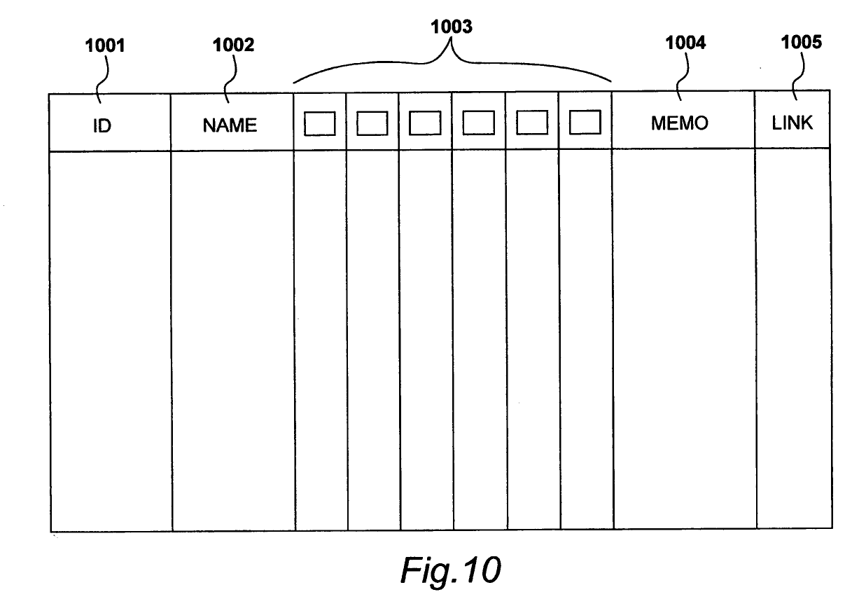

### FIG. 10

An example of a database table is shown in FIG. 10. In the database table, column 1001 (possibly a primary key) records a unique identification label for the interaction. Thus, in this way, each interaction includes a unique label. In situations where many central stations are provided, the label may include a prefix that identifies the particular station at which the interaction was recorded.

Column 1002 identifies the name of the subject and similar columns may be provided for identifying the name of the counsellor. It would then be possible for a particular query to make reference to the interaction table, as shown in FIG. 10, along with a table relating to the subject student and a table relating to the counsellor.

The columns shown generally at 1003 represent check boxes allowing various attributes to be checked by the counsellor. Thus, these check boxes may relate to particular attributes of the interaction. For example, they may identify the reason for the praise being given such as whether the issue arose during a particular class or, as in the example described previously, whether the issue arose outside class. Thus, additional check boxes could be defined relating to particular attributes, which are helpful if, for example, the environment is sensitive to a particular issue. In this way, if a particular issue is being addressed and the establishment wishes to show examples of how the issue is addressed, it is possible for a query to be defined which will show all interactions for which the relevant box has been checked.

Column 1004 allows a memo to be added which would allow free text to be entered by the counsellor. Column 1005 includes a link to the stored audio and video files.

At the end of the interaction it is possible for the counsellor to produce a recording using recording device 906. It is also possible for the recorded audio and video to be conveyed over network 108 to the local counselling station 102.

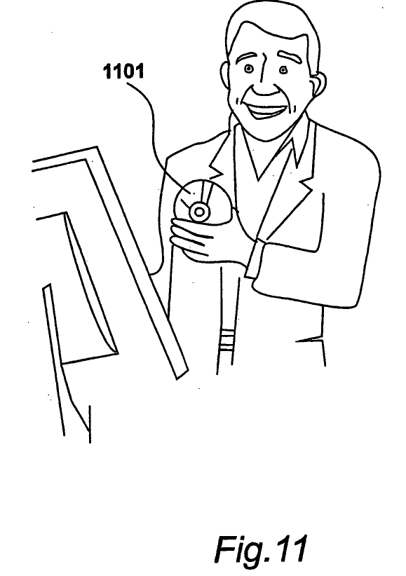

### FIG. 11

In a preferred embodiment, the praise pod 102 itself does not include the capability for producing a local recording of the interaction but the recorded files are available from a local network. Given an environment of this type, it is then possible for a local teacher to produce a recording of the interaction for use in various ways.

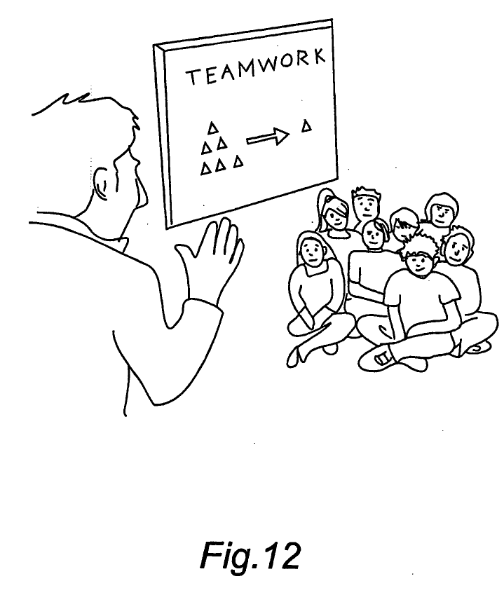

### FIG. 12

It is possible for a number of recordings to have been produced relating to a particular project. Thus, it is then possible for a meeting to be held with the class at which the various recordings are considered and analysed. At this point, where appropriate, it would be possible to give recordings to individual students.

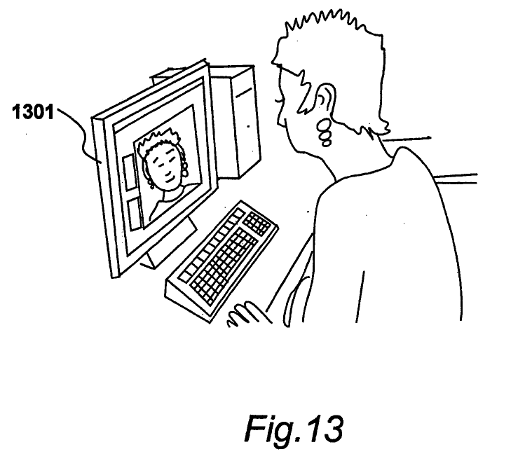

### FIG. 13

Upon receiving a recording, a parent may view the recorded material on a local computer system 1301. This reassures parents to the effect that good progress is being made and also allows parents to provide feedback where appropriate.

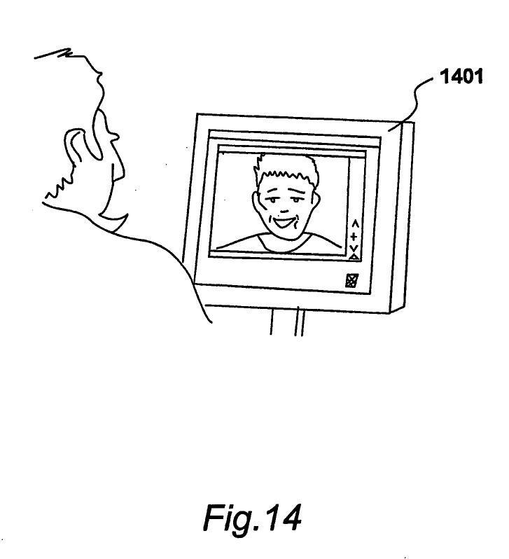

### FIG. 14

Computer systems may be provided in staff rooms and similar areas, such as system 1401. In this way, it is possible for teachers to discuss the development of their students with other members of staff, parents and the external counsellors.

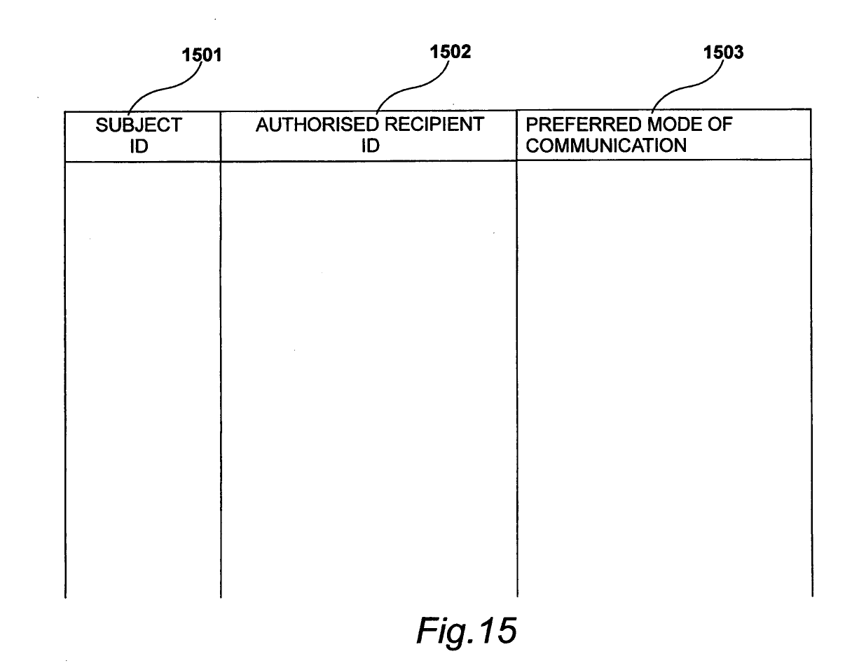

### FIG. 15

A further example of a database table is shown in FIG. 15. In an embodiment, a subject may have at least one associated authorised recipient of data resulting from an interaction. The authorised recipient may then identify a preferred mode of communication of the data. In a database table, column 1501 records a unique identification label for a subject. Column 1502 identifies unique identification label for an authorised recipient, whilst column 1503 identifies a preferred mode of communication for the authorised recipient. For example, the subject may be a pupil, and the authorised recipient may be a guardian of the pupil. The authorised recipient of a subject may specify that a recorded interaction is to be forwarded to them by means of a communication to their mobile phone. As an alternative, a preference can be specified for receiving a communication to an email address. However, the authorised recipient may indicate that they prefer for data relating to a recorded interaction to remain on a network. Where a preferred of mode of communication is indicated, further data relating to an appropriate method of transfer of data for that mode of communication may also be identified in the database. In this way, a recorded interaction may be communicated to a third party by means of a data stream instead of a physical data carrier, such as a DVD. The database may further include a register of recorded interaction data that has been communicated to an authorised recipient.

In an embodiment, a reward scheme is operated, to the effect that a subject is rewarded with a predetermined number of “praise” points for a visit to the praise pod. Thus, over a particular period of time, a subject can monitor their accrual of points. In an embodiment, data relating to points awarded to a subject may also be communicated to an authorised recipient.

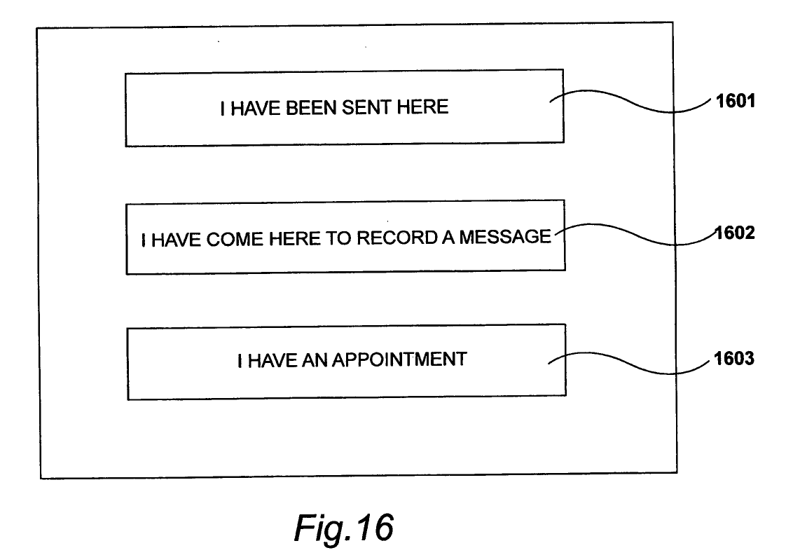

### FIG. 16

A screen presenting options to a visitor to a praise pod is illustrated in FIG. 16. The screen presents options that are selectable by the visitor to indicate the nature of their use of the pod. The visitor can indicate that they have been sent to the pod by selecting option 1601. Typically, this option is selected when the visitor has been sent to the pod to communicate with an authorised host, in direct response to recognition by a third party that the visitor has displayed good behaviour.

A further option allows a subject to indicate that they have come to the praise pod to record a message. Thus, by selecting option 1602, a subject may record a message without interaction with an authorised host at a central station. This option allows, for example, a pupil or parent or member of staff to leave praise messages for other people. The subject may therefore record positive feedback or praise for an intended recipient. Preferably, this option allows a subject to identify an intended recipient in order for the message to be communicated to that intended recipient, possibly in a manner as described with reference to FIG. 15, in which a recorded interaction may be communicated to an authorised recipient. Thus, a circle of praise within an environment may be reinforced by different categories of persons within that environment. It is to be appreciated that subjects may utilise the option to record a message for themselves. In this way, the intended recipient is the subject. It is found that positive self-talk can be a useful therapeutic tool. A subject may therefore benefit by recording messages that in effect become entries in a self-recorded diary. Preferably, a database allows different interactions with a particular subject to be collated. This feature usefully allows a series of entries to be communicated all at once to the subject, an authorised recipient, an intended recipient, or into a report such as a report of the type that is typically prepared when a subject leaves one educational environment to join another. Thus the praise pod may provide for a life narrative story of a subject to be built up. A record of this type can be valuable to a child that experiences changes of guardianship. For example, a child receiving social care, for example whilst in a authority run residential home or in the care of temporary foster parents, can provide a means of demonstrating positive aspects of their personality to a third party on demand by means of the record of interactions.

A third option allows a subject to indicate that they are attending the praise pod because they have an appointment. By selecting 1603 the subject can indicate that they are present for the appointment. The appointment itself may be arranged to allow the subject to converse with, for example, a mentor in order to discuss progress or a problem, or with a student having a different mother tongue in order to develop their skills in a foreign language. Clearly an appointment may be used in the normal course of teaching in an educational environment, and may form an integral part of certain learning related activities. Another nature of an appointment is to provide a pleasant surprise or treat for the subject. The subject may be encouraged to attend an appointment under the guise of a normal learning activity, yet when they initiate the appointment they find that in place of the expected authorised host, they re presented with a personality known to be acclaimed by the subject. For example the subject may be surprised to see, and to be able to interact with, a celebrity. As previously described, the disclosed system allows this unusual appointment to be recorded as a memento for the subject. In another example, an appointment may be made with an authorised host that is an external Fig. of authority, for example a law enforcement officer. With the subject located in the comfortable and non-threatening environment of the pod, the subject can interact with the authority Fig. and, in appropriate instances, receive praise from the authority Fig.. In this way, an agreeable relationship between the subject and the authority Fig., which may otherwise have little opportunity to develop, may be encouraged.

What is claimed is:

1. Apparatus for recording interactions between an authorised host and each of a plurality of subjects, for use in reinforcing good behaviour of the subject, comprising:
a central station for hosting said authorised host;
a plurality of interview stations for receiving subjects;
a network for connecting the central station to the interview stations; and
a database for recording details of interactions between the authorised host and received subjects, wherein:
each of said interview stations comprises a substantially enclosed pod-like structure for receiving a subject and devices for establishing an audio and video connection to the central station via the network; and
the central station includes devices for maintaining an audio and video connection with an interview station to maintain an audio and video interaction between the authorised host and a received subject, audio and video recording equipment for recording interactions, and an input device for receiving textural input from the authorised host thereby allowing the authorised host to populate appropriate fields of the database.

2. Apparatus according to claim 1, wherein a plurality of central stations is connected to the network.

3. Apparatus according to claim 2, wherein an interaction is initiated by a subject and a central station is allocated to the initiating subject.

4. Apparatus according to claim 1, wherein the database includes details of recorded audio and video so as to relate said audio and video to data entries.

5. Apparatus according to claim 1, including a medium recording device at the central station and/or at the interview stations for recording the interaction onto a physical data carrier.

6. Apparatus according to claim 1, wherein the database includes details of an authorised recipient of a recorded interaction for a particular subject and details of a preferred mode of communication of the recorded interaction to the authorised recipient.

7. A method of recording interactions between an authorised host and each of a plurality of subjects, for use in reinforcing good behaviour of the subject, comprising the steps of:
hosting an authorised host at a central station;
receiving a subject at a subject receiving station; and
connecting the central station to the subject receiving station by a network, wherein
an interaction between a subject and the authorised host is recorded; and
the authorised host adds related textural data to a relational database.

8. A method according to claim 7, wherein the interaction takes place in an educational environment.

9. A method according to claim 8, wherein a plurality of educational establishments each have access to a respective subject receiving station and each of said subject receiving stations communicates with the central station over said network.

10. A method according to claim 7, wherein the authorised host provides positive feedback or praise to an interacting subject.

11. A method according to claim 7, wherein a recording of the interaction is distributed to an authorised recipient.

12. A method according to claim 8, wherein said authorised host is a counsellor, a teacher, a pupil, a mentor, an external Fig. of authority.

13. A method according to claim 7, wherein said subject receiving station is substantially pod-like.

14. An interview station comprising:
apparatus for maintaining an audio and video connection to a central station hosted by an authorised host; and
an enclosure for enclosing said apparatus and a subject positioned so as to interact with said apparatus.

15. A station according to claim 14, wherein said enclosure is substantially pod-like.

16. A station according to claim 14, including apparatus conFig.d to allow a received subject to record positive feedback or praise for an intended recipient.

17. A station according to claim 16, wherein said intended recipient is said received subject.

18. A system responsive to executable instructions conFig.d to:
maintain an audio and video link to at least one remote station;
record an audio and video interaction between a local authorised host and a remote subject; and
facilitate the populating of a database in response to input data generated by said local authorised host.

19. A system according to claim 18, including distribution apparatus for distributing recorded interaction data.

20. A system according to claim 19, wherein said database allows different interactions with said remote subject to be collated to provide a series of interactions.
